(19) United States
(12) Patent Application Publication
(10) Pub. No.: US 2025/0353513 A1
(43) Pub. Date: Nov. 20, 2025

(54) SYSTEM AND METHOD FOR DETERMINING COVERAGE OF A VEHICLE TECHNOLOGICAL FIELD

(71) Applicant: HERE Global B.V., Eindhoven (NL)

(72) Inventors: Jingwei XU, Buffalo Grove, IL (US); Yuxin GUAN, Chicago, IL (US); Leon STENNETH, Chicago, IL (US); Bruce BERNHARDT, Wauconda, IL (US); Advait Mohan RAUT, Virar West (IN); Alex AVERBUCH, Buffalo Grove, IL (US); Weimin HUANG, Chicago, IL (US)

(21) Appl. No.: 18/666,447

(22) Filed: May 16, 2024

(51) Int. Cl. B60W 50/14; G01C 21/32

(52) U.S. Cl. CPC B60W 50/14; G01C 21/32; B60W 2050/146; B60W 2530/13; B60W 2556/40

(57) ABSTRACT

The disclosure provides a system, a method, and a computer program product for determining coverage of a vehicle. The system is configured to, for example, acquire sensor data and vehicle data from a user equipment. The sensor data is associated with a region including a plurality of roads. Further, the system is configured to determine a function class of each of the plurality of roads based on the sensor data. Further, the system is configured to determine a type of a vehicle associated with the user equipment, based on the vehicle data. The system is configured to further determine coverage data of the vehicle for each of the plurality of roads based on the function class of a respective road of the plurality of roads and the type of the vehicle. Further, a first notification associated with the coverage of the vehicle, is generated as output.

### TECHNOLOGICAL FIELD

The present disclosure generally relates to routing and navigation systems, and more particularly relates to systems and methods for determining coverage of a vehicle for routing and navigation applications.

### BACKGROUND

Navigation applications for a vehicle generally rely on data stored in a map database for identifying various navigation related entities such as road objects, links, lane markings, coverage, and the like. In case the vehicle is an autonomous vehicle, accurate detection of navigation related entities becomes more important to provide a safe and reliable navigation service. Existing methods provide road traffic information and incident information by aggregating probe vehicle geolocation data and sensor data. With the fast deployment of connected vehicles including all level of autonomous vehicles, it is challenging for navigation systems to provide the probe vehicle or sensor vehicle coverage analysis to make sure accurate reporting of traffic and/or incident related data, including coverage, to support autonomous driving features and reduce the hidden risks of driving safety.

Therefore, it is required to provide a method or a system, which is able to determine coverage of a vehicle accurately.

### BRIEF SUMMARY

Accordingly, in order to provide accurate, safe, and reliable navigation assistance, it is important to determine coverage of a vehicle accurately and update it in the map database. Further, even more safe and user oriented navigation services can be provided to the end users. To this end, the data utilized for providing the navigation assistance should consider accurate and up-to-date navigation instructions for passage of vehicle through various regions and routes. Especially, in the context of navigation assistance for autonomous vehicles and semi-autonomous vehicles to avoid inaccurate navigation, it is important that the assistance provided is real-time, up-to-date, safe, and accurate. There is a need of a system that may determine coverage of a vehicle based on the real time observations of traffic and incidents received from a plurality of vehicles.

Example embodiments of the present disclosure provide a system, a method, and a computer program product for determining coverage of a vehicle in order to overcome the challenges discussed above, to provide the solutions envisaged as discussed above.

In one aspect, a system for determining coverage of a vehicle, which is measured in terms of coverage data, is disclosed. The system comprises a memory configured to store computer-executable instructions; and at least one processor configured to execute the computer-executable instructions to acquire sensor data and vehicle data from a user equipment, the sensor data is associated with a region including a plurality of roads. The at least one processor is further configured to determine a function class of each of the plurality of roads based on the sensor data. The at least one processor is further configured to determine a type of a vehicle associated with the user equipment, based on the vehicle data. The at least one processor is further configured to determine coverage data of the vehicle for each of the plurality of roads based on the function class of a respective road of the plurality of roads and the type of the vehicle. Further, the at least one processor is configured to output a first notification associated with the coverage of the vehicle.

In additional system embodiments, the at least one processor is further configured to compare the coverage data of the vehicle for each of the plurality of roads with a respective threshold value of a plurality of threshold values. The at least one processor is further configured to output a second notification based on whether the coverage data of the vehicle for at least one road of the plurality of roads is one of equal to or greater than at least one threshold value for the at least one road. The plurality of threshold values include the at least one threshold value. The at least one processor is further configured to output a third notification when the coverage data of the vehicle for the at least one road is less than the at least one threshold value.

In additional system embodiments, the at least one processor is further configured to control a display device to display a warning based on the third notification. Further, the coverage data of the vehicle for each of the plurality of roads indicates mileage on the respective road. Further, the at least one processor is configured to calculate total mileage of the vehicle in the region based on analysis of the mileage on each of the plurality of roads.

In additional system embodiments, the at least one processor is further configured to generate statistical data metrics for the vehicle on each of the plurality of roads based on the function class of the respective road and the type of the vehicle. The at least one processor is further configured to control a display device to display the generated statistical data metrics for the vehicle.

In additional system embodiments, the at least one processor is further configured to execute histogram analysis for the vehicle on each of the plurality of roads based on the generated statistical data metrics. The at least one processor is further configured to classify the generated statistical data metrics based on a degree of importance of a specific time period. Further, the at least one processor is configured to execute statistical analysis on the classified statistical data metrics based on the degree of importance of the specific time period.

In additional system embodiments, the vehicle data includes an identifier of the vehicle. Further, the at least one processor is configured to determine the type of the vehicle based on the identifier of the vehicle. Further, the vehicle comprises a plurality of sensors. The at least one processor is further configured to generate statistical data metrics for the vehicle based on a category of each sensor of the plurality of sensors.

In additional system embodiments, the sensor data indicates at least one of a driving condition of the vehicle in the region or a surrounding environmental condition of the vehicle. The at least one processor is further configured to receive dynamic data from a server based on the reception of the sensor data. Further, the at least one processor is configured to execute a map matching process for the vehicle based on the sensor data and the dynamic data. The at least one processor is further configured to determine the coverage of the vehicle for each of the plurality of roads based on the execution of the map matching process.

In another aspect, a method for determining coverage of a vehicle is provided. The method comprises acquiring sensor data and vehicle data from a user equipment, where the sensor data is associated with a region including a plurality of roads. The method further comprises determining a function class of each of the plurality of roads based on the sensor data. Further, the method comprises determining a type of a vehicle based on the vehicle data. The method further comprises determining coverage of the vehicle for each of the plurality of roads based on the function class of a respective road of the plurality of roads and the type of the vehicle. Further the method comprises outputting a first notification associated with the coverage data of the vehicle.

In additional method embodiments, the method further comprises comparing the coverage data of the vehicle for each of the plurality of roads with a respective threshold value of a plurality of threshold values. The method further comprises outputting a second notification based on whether the coverage data of the vehicle for at least one road of the plurality of roads is one of equal to or greater than at least one threshold value for the at least one road, where the plurality of threshold values includes the at least one threshold value. Further the method comprises outputting a third notification when the coverage data of the vehicle for the at least one road is less than the at least one threshold value.

In additional method embodiments, the method further comprises controlling a display device to display a warning based on the third notification. Further, the coverage data of the vehicle for each of the plurality of roads indicates mileage on the respective road. The method further comprises calculating total mileage of the vehicle in the region based on analysis of the mileage on each of the plurality of roads.

In additional method embodiments, the method further comprises generating statistical data metrics for the vehicle on each of the plurality of roads based on the function class of the respective road and the type of the vehicle. Further, the method comprises controlling a display device to display the generated statistical data metrics for the vehicle.

In additional method embodiments, the method further comprises receiving dynamic data from a server based on the reception of the sensor data. Further, the method comprises executing a map matching process for the vehicle based on the sensor data and the dynamic data. The method further comprises determining the coverage of the vehicle for each of the plurality of roads based on the execution of the map matching process.

In yet another aspect, a computer program product comprising a non-transitory computer readable medium having stored thereon computer executable instructions which when executed by at least one processor, cause the processor to carry out operations for determining a coverage of a vehicle, the operations comprise acquiring sensor data and vehicle data from a user equipment, wherein the sensor data is associated with a region including a plurality of roads. Further, the operations comprise determining a function class of each of the plurality of roads based on the sensor data. Additionally, the operations comprise determining a type of a vehicle based on the vehicle data. Further, the operations comprise determining coverage data of the vehicle for each of the plurality of roads based on the function class of a respective road of the plurality of roads and the type of the vehicle. Further, the operations comprise outputting a first notification associated with the coverage data of the vehicle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for determining coverage of a vehicle, in accordance with an example embodiment;

FIG. 2A illustrates a block diagram of the system of FIG. 1, in accordance with an example embodiment;

FIG. 2B illustrates an exemplar map database record storing data, in accordance with one or more example embodiments;

FIG. 2C illustrates another exemplar map database record storing data, in accordance with one or more example embodiments;

FIG. 2D illustrates another exemplar map database storing data, in accordance with one or more example embodiments;

FIG. 3 illustrates a schematic diagram of a working example of the system of FIG. 2A, in accordance with an example embodiment;

FIG. 4 illustrates a block diagram of a working example of the system, in accordance with an example embodiment;

FIG. 5 illustrates a flow diagram of a method for determining coverage of a vehicle, in accordance with an example embodiment; and

FIG. 6 illustrates another flow diagram of a method for determining coverage of a vehicle, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles.

### End of Definitions

Embodiments of the present disclosure may provide a system, a method, and a computer program product for determining coverage data of a vehicle and update it on map data. The map data may be associated with a region, such as a construction/road works site, highway, city area and the like. With 5G development, vehicles are capable of reporting all kinds of vehicle sensor data to the back end, including road work, road construction, real time traffic, hazard warning, road signs, safety cameras, on-street parking, sensor data and the like. With the fast deployment of vehicles including all level of autonomous vehicles, it is challenging for the existing navigation systems to provide the probe vehicle or sensor vehicle coverage analysis to make sure the reporting traffic and/or incident qualities including coverage to support autonomous driving features and reduce the hidden risks of driving safety. In addition, the coverage and statistical analysis for a specific level of autonomous vehicle in a specific region may help for the autonomous vehicle driving quality. Insurance companies can also use vehicle sensor data coverage analysis to evaluate the risk of determining the insurance premium.

To that end, it would be advantageous to provide methods and systems for predicting coverage analysis of a vehicle to accurately provide the map data such that the unwanted situations such as road accidents, traffic congestions, and increased travel time may be avoided. The methods and systems disclosed herein facilitate updated navigation instructions related to routing of traffic.

In this manner, the methods and systems disclosed herein may provide efficient and user-friendly techniques for determining coverage of a vehicle. Further, in some embodiments, most of the processing is done by a remote server based or cloud-based server, so the user may be able to leverage fast processing and improved storage benefits provided by the systems and methods disclosed herein. Further, data for generating navigation instructions using the methods and systems disclosed herein may be gathered through a number of techniques, such as historical map data usage, real time data from map service providers and the like. Thus, the navigation instructions may be generated based on up-to-date and real time data, providing accurate and reliable navigation services to the users. These and other technical improvements of the invention will become evident from the description provided herein.

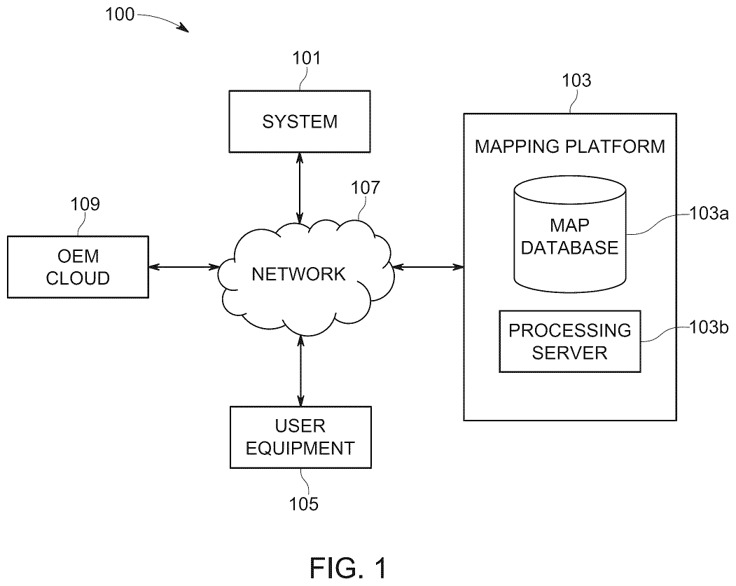

The system, the method, and the computer program product facilitating determination of coverage of a vehicle are described with reference to FIG. 1 to FIG. 6.

FIG. 1 illustrates a schematic diagram of a network environment 100 of a system for determining coverage of a vehicle, in accordance with an example embodiment. The system 101 may be communicatively coupled to a mapping platform 103, a user equipment 105 and an OEM (Original Equipment Manufacturer) cloud 109, via a network 107. The components described in the network environment 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud based application, a remote server based service, a remote server based application, a virtual computing system, a remote server platform or a cloud based platform. As such, the system 101 may be configured to operate outside the user equipment 105. However, in some example embodiments, the system 101 may be embodied within the user equipment 105, for example as a part of an in-vehicle navigation system, a navigation app in a mobile device and the like. In each of such embodiments, the system 101 may be communicatively coupled to the components shown in FIG. 1 to conduct the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle to generate navigation information in a region. Further, in one embodiment, the system 101 may be a standalone unit configured to generate navigation information in the region for the vehicle. Alternatively, the system 101 may be coupled with an external device such as the autonomous vehicle. In some embodiments, the system 101 may be a processing server 103b of the mapping platform 103 and therefore may be co-located with or within the mapping platform 103. In some other embodiments, the system 101 may be an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103.

The mapping platform 103 may comprise a map database 103a for storing map data and a processing server 103b. The map database 103a may store node data, road segment data, link data, point of interest (POI) data, link identification information, heading value records, data about various geographic zones, regions, pedestrian data for different regions, heatmaps or the like. Also, the map database 103a further includes speed limit data of different lanes, cartographic data, routing data, and/or maneuvering data. Additionally, the map database 103a may be updated dynamically to cumulate real time traffic data. The real time traffic data may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In an embodiment, the map database 103a may store data of different zones in a region. In one embodiment, the map database 103a may further store historical traffic data that includes travel times, average speeds and probe counts on each road or area at any given time of the day and any day of the year. In an embodiment, the map database 103a may store the probe data over a period of time for a vehicle to be at a link or road at a specific time. The probe data may be collected by one or more devices in the vehicle such as one or more sensors or image capturing devices or mobile devices. In an embodiment, the probe data may also be captured from connected-car sensors, smartphones, personal navigation devices, fixed road sensors, smart-enabled commercial vehicles, and expert monitors observing accidents and construction. In an embodiment, the map data in the map database 103a may be in the form of map tiles. Each map tile may denote a map tile area comprising plurality of road segments or links in it. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link and nodes can be associated with attributes, such as geographic coordinates, street names, address ranges, speed limits, turn restrictions at intersections, and other navigation related attributes. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, navigation instruction generation and other functions, by a navigation device, such as by the user equipment 105. The navigation-related functions may correspond to vehicle navigation, pedestrian navigation, navigation instruction suppression, navigation instruction generation based on user preference data or other types of navigation. The compilation to produce the end user databases may be performed by a party or entity separate from the map developer. For example, a customer of the map developer, such as a navigation device developer or other end user device developer, a navigation app service provider and the like may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 105 to provide navigation and/or map-related functions. For example, the map database 103a may be used with the user equipment 105 to provide an end user with navigation features. In such a case, the map database 103a may be downloaded or stored locally (cached) on the user equipment 105.

The processing server 103b may comprise processing means, and communication means. For example, the processing means may comprise one or more processors configured to process requests received from the user equipment 105. The processing means may fetch map data from the map database 103a and transmit the same to the user equipment 105 via OEM cloud 109 in a format suitable for use by the user equipment 105. In one or more example embodiments, the mapping platform 103 may periodically communicate with the user equipment 105 via the processing server 103b to update a local cache of the map data stored on the user equipment 105. Accordingly, in some example embodiments, the map data may also be stored on the user equipment 105 and may be updated based on periodic communication with the mapping platform 103.

In some example embodiments, the user equipment 105 may be any user accessible device such as a mobile phone, a smartphone, a portable computer, and the like, as a part of another portable/mobile object such as a vehicle. The user equipment 105 may comprise a processor, a memory, and a communication interface. The processor, the memory and the communication interface may be communicatively coupled to each other. In some example embodiments, the user equipment 105 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 105 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 105. Additional, different, or fewer components may be provided. In one embodiment, the user equipment 105 may be directly coupled to the system 101 via the network 107. For example, the user equipment 105 may be a dedicated vehicle (or a part thereof) for gathering data for development of the map data in the database 103a. In some example embodiments, at least one user equipment such as the user equipment 105 may be coupled to the system 101 via the OEM cloud 109 and the network 107. For example, the user equipment 105 may be a consumer vehicle (or a part thereof) and may be a beneficiary of the services provided by the system 101. In some example embodiments, the user equipment 105 may serve the dual purpose of a data gatherer and a beneficiary device. The user equipment 105 may be configured to capture sensor data associated with a road which the user equipment 105 may be traversing. The sensor data may for example be image data of road objects, road signs, or the surroundings. The sensor data may refer to sensor data collected from a sensor unit in the user equipment 105. In accordance with an embodiment, the sensor data may refer to the data captured by the vehicle using sensors. The user equipment 105, may be communicatively coupled to the system 101, the mapping platform 103 and the OEM cloud 109 over the network 107.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 107 is coupled directly or indirectly to the user equipment 105 via the OEM cloud 109. In an example embodiment, the system may be integrated in the user equipment 105. In an example, the mapping platform 103 may be integrated into a single platform to provide a suite of mapping and navigation related applications for OEM devices, such as the user devices and the system 101. The system 101 may be configured to communicate with the mapping platform 103 over the network 107. Thus, the mapping platform 103 may enable provision of cloud-based services for the system 101, such as, updating data about coverage analysis in the OEM cloud 109 in batches or in real-time.

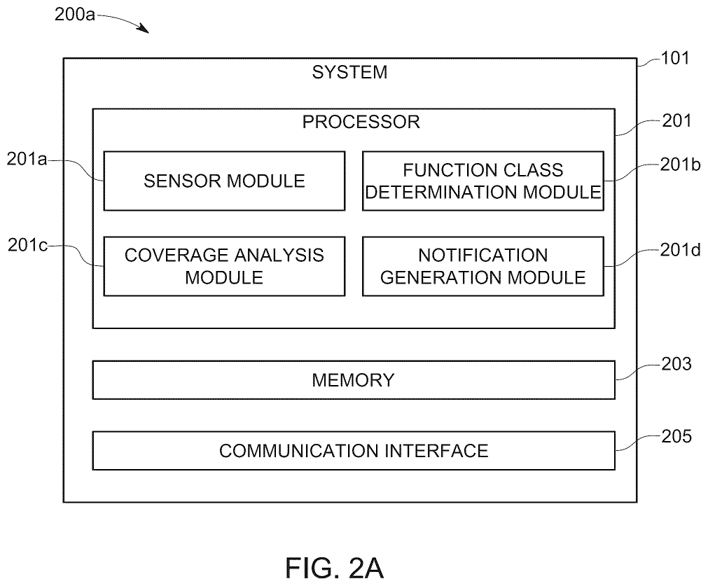

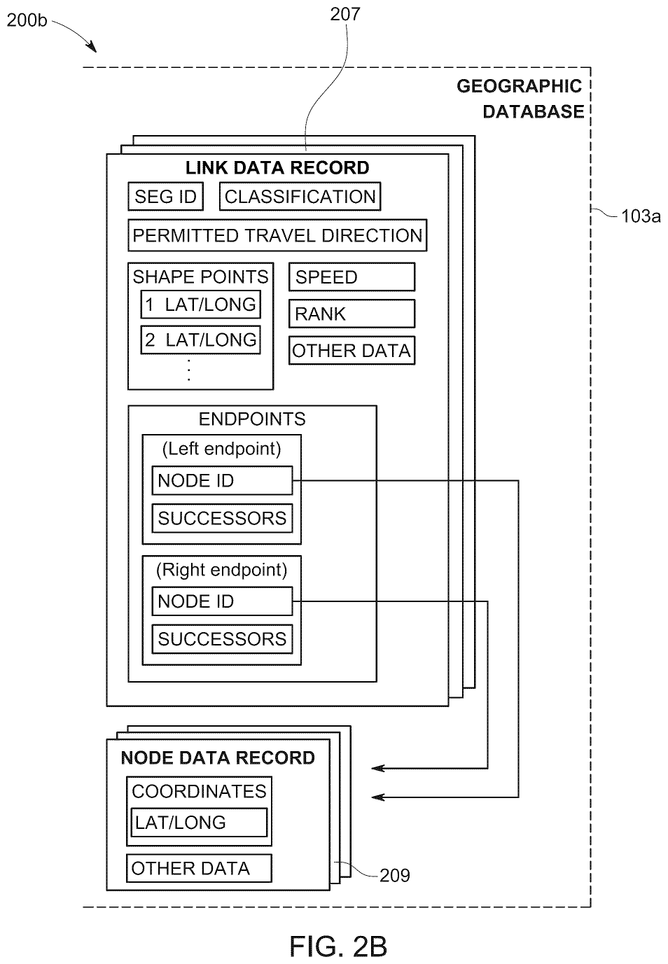

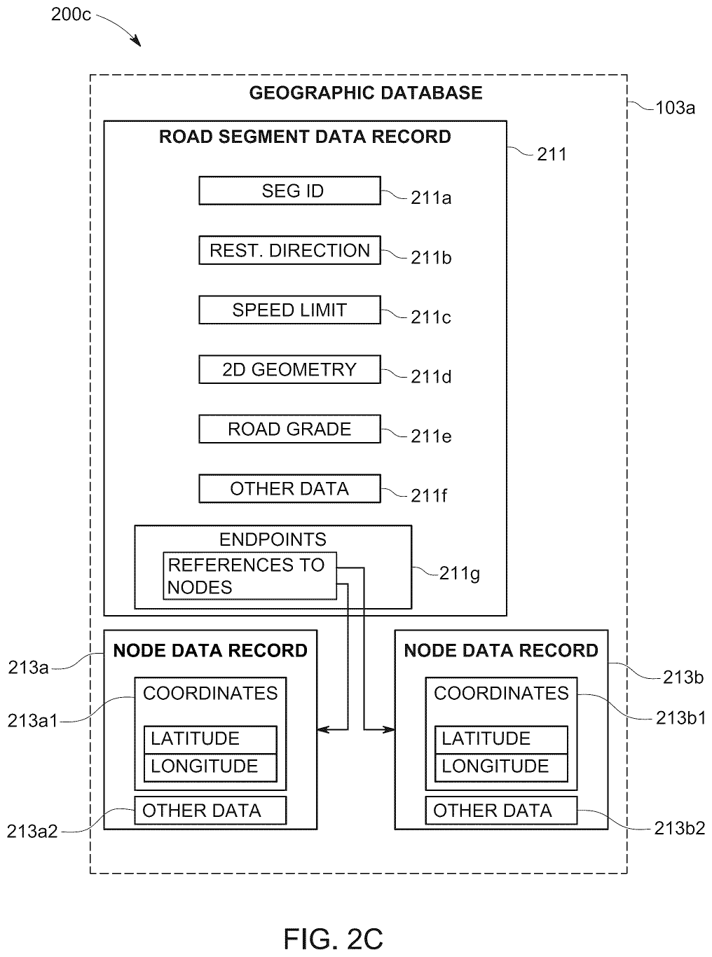

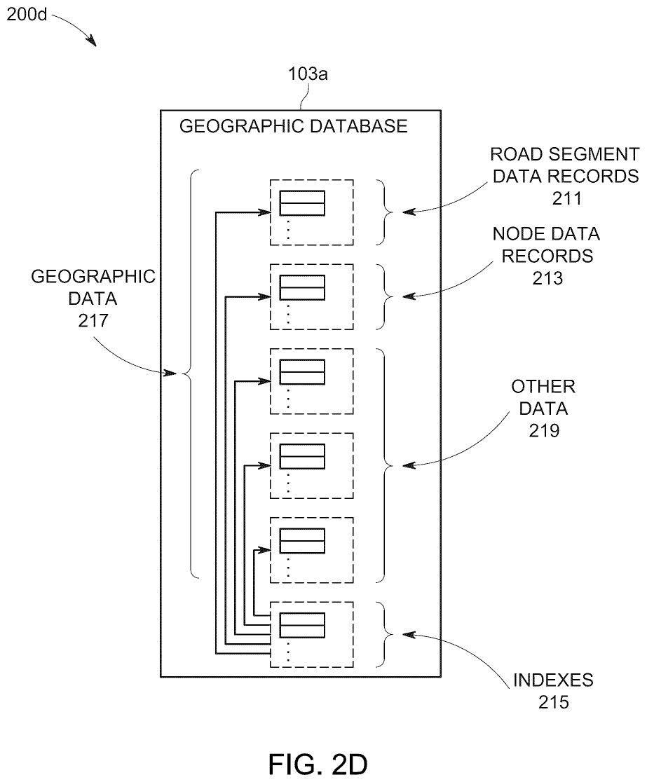

FIG. 2A illustrates a block diagram 200a of the system 101 for determining coverage of a vehicle, in accordance with an example embodiment. The system 101 may include at least one processor 201 (hereinafter, also referred to as “processor 201”), at least one memory 203 (hereinafter, also referred to as “memory 203”), and at least one communication interface 205 (hereinafter, also referred to as “communication interface 205”). The processor 201 may include a sensor module 201a, a function class determination module 201b, a coverage analysis module 201c, and a notification generation module 201d. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes and the like, big data analysis, traffic redirection, and sensor-based data collection by using the cloud-based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to conduct various functions in accordance with an example embodiment of the present invention. For example, the memory 203 may be configured to buffer input data for processing by the processor 201.

As exemplarily illustrated in FIG. 2A, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The sensor module 201a may be configured to receive data from one or more sensors including but not limited to acoustic sensors such as a microphone array, position sensors such as a GPS sensor, a gyroscope, a LIDAR (Light detection and tanging) sensor, a proximity sensor, motion sensors such as accelerometer, an image sensor such as a camera and the like. Different sensors equipped in a vehicle can be used for perception and localization detection which are two of the fundamental technologies in autonomous driving. Radar is used to detect the object's distance, velocity, range, by sending radio waves. The most use cases are parking assistance and blind detection. LIDAR is used to determine the object's distance by creating the 3D rendering images of the autonomous driving vehicle's surrounding by spinning laser emitting millions of light pulses per second to view and measure each point the laser scanned. Camera is used to detect road surface, lane marking, road signs through latest CNN (Convolutional Neural Network) and DNN (Deep Neural Network) machine learning image technologies. Satellite system like GPS, GLONASS, BEIDOU, together with Wi-Fi, Bluetooth, and inertial sensors like Gyro and Accelerometer, and HD-MAP are used to help autonomous vehicle determine its precise location. V2X sensors (4G/5G modem) helps exchange the information including real time traffic, road hazard, weather, parking between the autonomous driving vehicle and back end infrastructure.

To that end, the sensor module 201a may be configured to acquire sensor data and vehicle data from a user equipment 105. The sensor data may be associated with a region including a plurality of roads. The region is a bounding region and is defined by making a polygon around the region in a map display. In one embodiment, the sensor data and the vehicle data is obtained from a connected vehicle during a drive. The sensor module 201a is configured to receive dynamic data from a server based on the reception of the sensor data. Dynamic data may include weather data, traffic data, incident data, map data, hazard warning data, traffic pattern data, and the like. The sensor data indicates at least one of a driving condition of the vehicle in the region or a surrounding environmental condition of the vehicle. The sensor data may include all the sensors equipped to detect the vehicle driving conditions or its surrounding driving environments like road signs, road conditions, and the like.

To that end, the function class determination module 201b is configured to determine a function class of each of the plurality of roads based on the sensor data received by the sensor module 201a. Once the sensor data in the form of the real time traffic, hazard warning, road signs, etc. is received by the sensor module 201a, the sensor data is processed to extract information related to a function class of each of the plurality of roads. Functional class is a road type indicator, which is used to classify roads depending on the speed, importance and connectivity of the road. The function class for any road may correspond to a value, depicted as FCx (where x is a number) that satisfies the criterion, 1≤FCx≤5. Thus, the function class may be represented as any of: FC1, FC2, FC3, FC4, and FC5. The value “x” of the function class represents one of the five levels:
1: allowing for high volume, maximum speed traffic movement
2: allowing for high volume, high speed traffic movement
3: providing a high volume of traffic movement
4: providing for a high volume of traffic movement at moderate speeds between
neighborhoods
5: roads whose volume and traffic movement are below the level of any functional class

For example, interstates and highways, are considered “Limited access roads” and are typically FC1 and/or FC2 type roads. Some roads, such as “arterial” roads are roads that fall into categorization of below limited access and above collector/local roads and are classified as FC2 plus FC3 & FC4. The local roads are classified as FC5 and include any leftover navigable roads such as alleys and dead-end streets. Different types of local roads include residential streets, avenues, and alleys. The local roads have the lowest speed limits and capacities in the hierarchy but have the highest access to property. In this manner, the function class determination 201b assigns a function class to each of the plurality of roads.

Further, in some embodiments, the dynamic data is received from a server by the sensor module 201a. The processor 201 may be configured to execute a map matching process for the vehicle based on the sensor data and the dynamic data. Further, the processor 201 is configured to perform map matching all OEM probe data on HD map. The sensor data received from the sensor module 201a, is aggregated, and accumulated on each link (road segment) in HD map. The aggregation of the sensor data may be based on vehicle provider ID, vehicle ID, and time stamp, geolocation data. As is known in conventional art, map matching is a procedure in which the vehicle's position is estimated by matching the global positioning system (GPS) and a reference HD map. A simple map-matching approach tailors the current position of the vehicle, based on the nearest landmarks onto a vector representation of a road network. A lane level map matching method is used for vehicle localization using the GPS and camera on the HD map. The map matching method relies on road link information, which indicates the center of each lane in the HD map. The position of the vehicle is estimated by matching the GPS and the reference HD map.

Further, the coverage analysis module 201c, in the processor 201, may be configured to determine coverage data of a vehicle for each of the plurality of roads. The coverage data is determined based on the function class of a respective road of the plurality of roads and the type of the vehicle. In some embodiments, the vehicle data obtained from the sensor module 201a, includes an identifier of the vehicle. The processor 201 may be configured to determine the type of the vehicle based on the identifier of the vehicle. The type of the vehicle may include all level of autonomous vehicles (L2-L5). In some embodiments, the coverage analysis module 201c may be configured determine the coverage of the vehicle for each of the plurality of roads based on the execution of the map matching process.

The coverage analysis may be based on the accumulating of data/time span period per region or polygon, per road function class, per provider, or other filters like rush hour vs non-rush hour, holiday vs non holiday, weekdays vs weekends. In some embodiments, the coverage data of the vehicle for each of the plurality of roads indicates mileage on the respective road. In some embodiments, the processor 201 may be further configured to calculate total mileage of the vehicle in the region based on analysis of the mileage on each of the plurality of roads. For example, the total mileage of the vehicle may be a sum of the respective mileages of the vehicle on each of the plurality of roads. In some embodiments, the processor 201 may be further configured to generate statistical data metrics for the vehicle on each of the plurality of roads based on the function class of the respective road and the type of the vehicle. The processor 201 may be configured to control a display device to display the generated statistical data metrics for the vehicle.

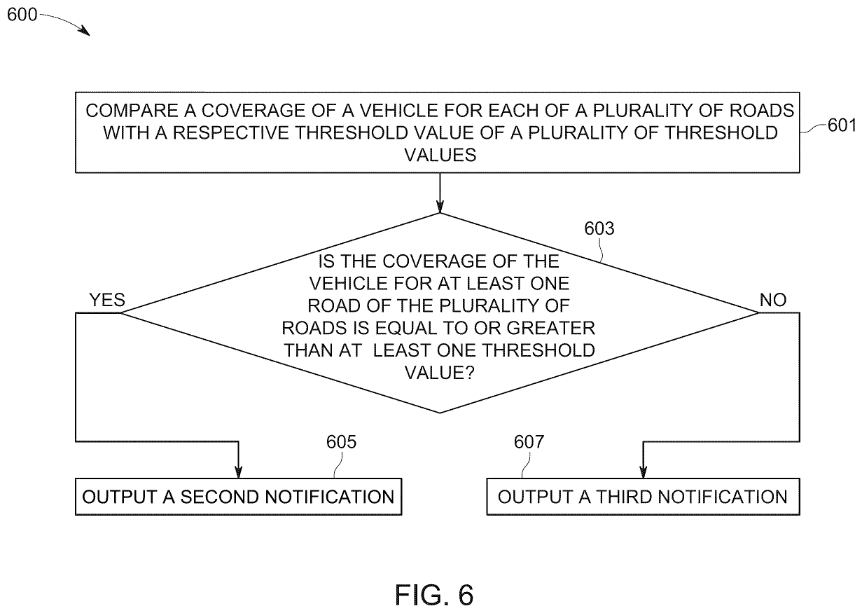

Further, the notification generation module 201d, in the processor 201, may be configured to output a first notification associated with the coverage data of the vehicle. The processor 201 may be configured to compare the coverage data of the vehicle for each of the plurality of roads with a respective threshold value of a plurality of threshold values. The notification generation module 201d may be configured to output a second notification if the coverage data of the vehicle, is one of equal to or greater than at least one threshold value. The notification generation module 201d may be configured to output a third notification when the coverage data of the vehicle for the at least one road is less than the at least one threshold value. In some embodiments, the notification generation module 201d may control a display device to display a warning based on the third notification. The warning may be an indication of poor performance of the vehicle. This is further explained in conjunction with FIG. 6.

The processor 201 is further configured to execute histogram analysis for the vehicle on each of the plurality of roads based on the generated statistical data metrics. The generated statistical data metrics is based on a degree of importance of a specific time period. The specific time period may include time span period per region or polygon, rush hour vs non-rush hour, holiday vs non holiday, weekdays vs weekends. In some embodiments, the processor 201 is further configured to execute statistical analysis on the classified statistical data metrics based on the degree of importance of the specific time period. As discussed in the previous paragraphs, the vehicle comprises a plurality of sensors. The degree of importance may, for example, be indicated as high, low, or medium. The degree of importance may be predetermined based on historical data analysis in some examples. The processor 201 may be configured to generate statistical data metrics for the vehicle based on a category of each sensor of the plurality of sensors.

The communication interface 205 may comprise input interface and output interface for supporting communications to and from the user equipment 105 or any other component with which the system 101 may communicate. The communication interface 205 may be any means such as a device or circuitry embodied in either hardware or a combination of hardware and software that is configured to receive and/or transmit data to/from a communications device in communication with the user equipment 105. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to manage receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms for enabling the system 101 to conduct information exchange functions in many different forms of communication environments. The communication interface enables exchange of information and instructions for detecting road zone and updating it on map data stored in the map database 103a.

FIG. 2B shows format of the map data 200b stored in the map database 103a according to one or more example embodiments. FIG. 2B shows a link data record 207 that may be used to store data about one or more of the feature lines. This link data record 207 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 207 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 207 indicate the position, (e.g., latitude, longitude, and optionally, altitude or elevation) of the selected shape points along the represented link.

Additionally, in the compiled geographic database, such as a copy of the map database 103a, there may also be a node data record 209 for each node. The node data record 209 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 211. The road segment data record 211 is configured to represent data that represents a road network. In FIG. 2C, the map database 103a contains at least one road segment data record 211 (also referred to as “entity” or “entry”) for each road segment in a geographic region.

The map database 103a that represents the geographic region of FIG. 2A also includes a database record 213 (a node data record 213a and a node data record 213b) (or “entity” or “entry”) for each node associated with the at least one road segment shown by the road segment data record 211. (The terms “nodes” and “segments” represent only one terminology for describing these physical geographic features and other terminology for describing these features is intended to be encompassed within the scope of these concepts). Each of the node data records 213a and 213b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 211 contained in the map database 103a. The road segment data record 211 includes a segment ID 211a by which the data record can be identified in the map database 103a. Each road segment data record 211 has associated with it information (such as “attributes”, “fields”, etc.) that describes features of the represented road segment. The road segment data record 211 may include data 211b that indicate the restrictions, if any, on the direction of vehicular travel permitted on the represented road segment. The road segment data record 211 includes data 211c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 211 may also include data 211d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 211 also includes road grade data 211e that indicate the grade or slope of the road segment. In one embodiment, the road grade data 211e include road grade change points and a corresponding percentage of grade change. Additionally, the road grade data 211e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 211e includes the road grade change points and an actual road grade value for the portion of the road segment after the road grade change point until the next road grade change point or end node. In a further embodiment, the road grade data 211e includes elevation data at the road grade change points and nodes. In an alternative embodiment, the road grade data 211e is an elevation model which may be used to determine the slope of the road segment.

The road segment data record 211 also includes data 211g providing the geographic coordinates (e.g., the latitude and longitude) of the end points of the represented road segment. In one embodiment, the data 211g are references to the node data records 211 that represent the nodes corresponding to the end points of the represented road segment.

The road segment data record 211 may also include or be associated with other data 211f that refer to various other attributes of the represented road segment. The various attributes associated with a road segment may be included in a single road segment record or may be included in more than one type of record which cross-reference each other. For example, the road segment data record 211 may include data identifying the name or names by which the represented road segment is known, the street address ranges along the represented road segment, and so on.

FIG. 2C also shows some of the components of the node data record 213 contained in the map database 103a. Each of the node data records 213 may have associated information (such as “attributes”, “fields”, etc.) that allows identification of the road segment(s) that connect to it and/or it is geographic position (e.g., its latitude and longitude coordinates). For the embodiment shown in FIG. 2C, the node data records 213a and 213b include the latitude and longitude coordinates 213a1 and 213b1 for their nodes. The node data records 213a and 213b may also include other data 213a2 and 213b2 that refer to various other attributes of the nodes.

Thus, the overall data stored in the map database 103a may be organized in the form of different layers for greater detail, clarity, and precision. Specifically, in the case of high definition maps, the map data may be organized, stored, sorted, and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 217 in the form of road segments/links, nodes, and one or more associated attributes as discussed above. Furthermore, attributes may refer to features or data layers associated with the link-node database, such as an HD lane data layer.

In addition, the map data 217 may also include other kinds of data 219. The other kinds of data 219 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 215. The indexes 215 may include various types of indexes that relate the different types of data to each other or that relate to other aspects of the data contained in the geographic database 103a.

The data stored in the map database 103a in the various formats discussed above may help in providing precise data for high definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIG. 2B, FIG. 2C and FIG. 2D.

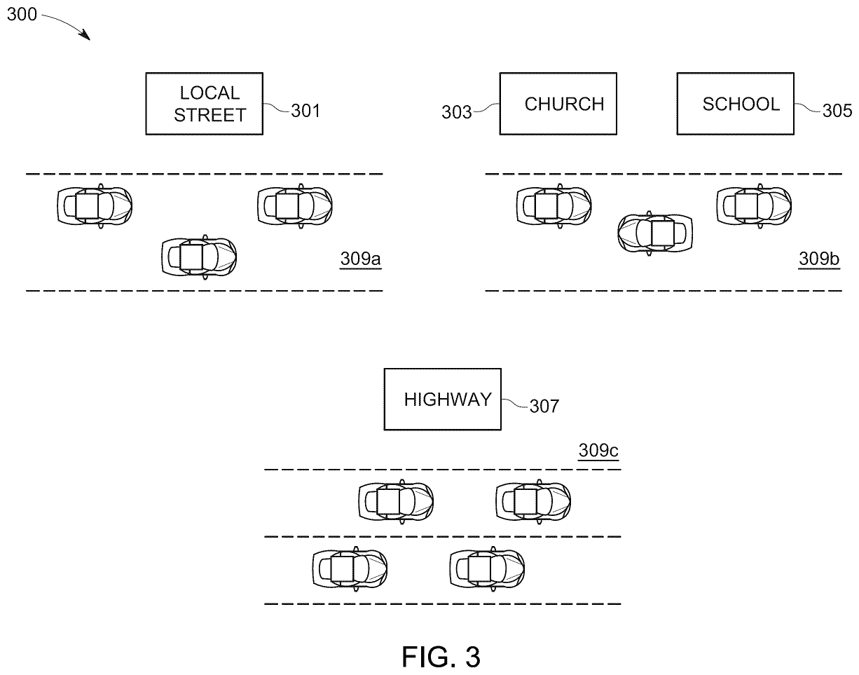

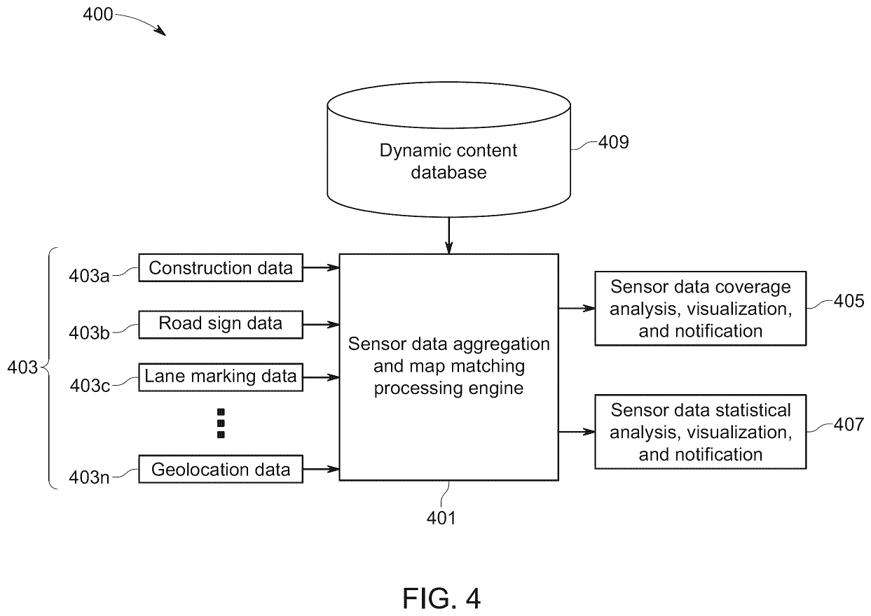

FIG. 3 illustrates a schematic diagram of a working example 300 of the system 101, in accordance with an example embodiment. FIG. 3 may include a local street 301, a church 303, a school 305, a highway 307, a plurality of roads, such as a road 309a, a road 309b and a road 309c (which are collectively referred to as the plurality of roads 309a-309c hereinafter). A plurality of vehicles associated with the plurality of roads 309a-309c are also shown. The plurality of vehicles may include such as an autonomous vehicle, a semiautonomous vehicle, or a manual vehicle. In various embodiments, the plurality of vehicles may be equipped with sensors for generating or collecting vehicular sensor data (also referred to as sensor data), related geographic/map data, etc. The exemplary scenario of the system 101 is further described in FIG. 4.

The plurality roads 309a-309c may belong to a function class of the previously described functional classes FC1-FC5. For example, the road 309a may be of functional class FC5, the road 309c may be of functional class FC1 and the like.

The road 309a may be situated in the local street 301. As the speed limit is lowest in the local roads, it may affect the coverage of a vehicle travelling on the road 309a. The coverage data available for the vehicle travelling on the road 309a may be less due to low speed and lesser distance covered during a time interval. On the other hand, the road is the highway 307, which generally provides the fastest method of travel and have low accessibility from neighboring roads. Often coverage of a vehicle is found to be good on highways when compared with other function classes.

Thus, the function class of a road affects the coverage data of a vehicle travelling on that road. The coverage data of the vehicle may indicate mileage of the vehicle on the corresponding road. The coverage data is dependent on the function class of the road and also on the type of the vehicle. Thus, the coverage data for the vehicle may vary from the type of road and the type of vehicle. Different brands of vehicles from different OEMs may thus have different coverage data. Such coverage data analysis for different OEMs may be useful to evaluate, such as regional autonomous vehicle dispatching services, driving quality analysis, insurance premium assessments, and the like. The coverage data determination is further explained in FIG. 4 below.

FIG. 4 illustrates a block diagram 400 of a working example of the system 101, in accordance with an example embodiment. FIG. 4 includes a sensor data aggregation and map matching processing engine block 401, connected sensor data 403, sensor data coverage analysis block 405, sensor data statistical analysis block 407 and a dynamic content database block 409. The connected sensor data 403 further includes plurality of sources of sensor data such as construction data 403a, road sign data 403b, lane marking data 403c, geolocation data 403n, and the like. The connected sensor data 403 includes road works related data such as cones, barrels, construction related signs, bollards, lane marking color, geolocation data and the like.

The dynamic content database block 409 is configured to receive dynamic data from a server. Dynamic data may include weather data, traffic data, incident data, map data, hazard warning data, traffic pattern data and the like. The dynamic data indicates at least one of a driving condition of the vehicle in the region or a surrounding environmental condition of the vehicle.

Sensor data aggregation and map matching processing engine 401 is configured to acquire the connected sensor data 403 and vehicle data as input. The vehicle data includes, such as an identifier of the vehicle that is used to determine the type of the vehicle based on the identifier of the vehicle. The obtained connected sensor data 403 and the vehicle data is aggregated, and map matched on an HD map in the sensor data aggregation and map matching processing engine 401. The aggregation of the sensor data may be based on the vehicle identifier, such as a vehicle provider ID, a vehicle ID, a time stamp, and geolocation data.

The aggregated and map matched data is then used to perform different types of analysis, such as coverage analysis and statistical analysis. The coverage analysis is performed by the sensor data coverage analysis block 405. The statistical analysis is performed by the sensor data statistical analysis block 407.

The sensor data coverage analysis block 405 may be configured to determine coverage data of a vehicle for each of the plurality of roads, such as for the plurality of roads. 309a-309c. The coverage data is determined based on the function class of a respective road of the plurality of roads and the type of the vehicle. The sensor data coverage analysis block 405 is further configured to generate visualization data for the coverage data and further generate notification based on the analysis and visualization of the coverage data. The coverage analysis may be based the accumulating of coverage data over a time span period per region or polygon, per road function class, per provider, or other filters like rush hour vs non-rush hour, holiday vs non holiday, weekdays vs weekends, and the like.

The sensor data statistical analysis block 407 may be configured to generate statistical data metrics for the vehicle on each of the plurality of roads based on the function class of the respective road and the type of the vehicle. The sensor data statistical analysis block 407 is configured to generate visualization data for the statistical data of the vehicle and generates notification based on the statistical data metrics and their visualization. The statistical data metrics and their visualization may include a histogram analysis per provider or OEM, per vehicle ID, per road function class, and the like.

In an example, the generated statistical data metrics are classified based on a degree of importance of a specific time period. For example, a rush hour time period is given a high degree of importance and compared to a non-rush hour time period. This degree of importance may be indicated by a numerical value. The statistical data metrics may then indicate coverage data of the vehicles travelling on a road during the rush hour period, vs, the non-rush hour period.

Similarly, the statistical data metrics for the vehicle may be determined based on a category of each sensor of the plurality of sensors, for example, whether it is a LiDAR sensor, a camera, the fog lights, a parking sensor, and the likes.

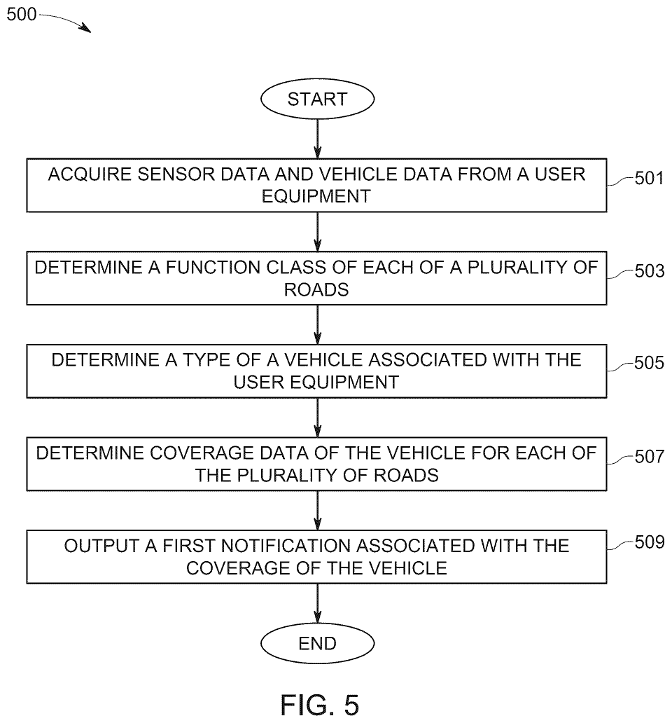

The sensor data analysis in the form of coverage data analysis and statistical data analysis may be conducted using methods and systems, such in the method described below in FIG. 5.

FIG. 5 illustrates a flow diagram of a method for determining coverage data of a vehicle, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 500 illustrated by the flowchart diagram of FIG. 5 is determining coverage of a vehicle. Fewer, more, or different steps may be provided.

At step 501, the method 500 comprises instructions to acquire sensor data and vehicle data from a user equipment. The sensor data is associated with a region including a plurality of roads. As discussed in FIG. 1, the user equipment 105 may be a dedicated vehicle (or a part thereof) for gathering data for determining coverage data of a vehicle. Additionally, the user equipment 105 may be any user accessible device such as a mobile phone, a smartphone, a portable computer, and the like, as a part of another portable/mobile object such as a vehicle. For example, when the user equipment is a vehicle, the sensor data and vehicle data is obtained from the vehicle during the drive through a region comprising the plurality of roads, through a wireless communication channel, in an online or an offline mode. The sensor data may for example be image data of road objects, road signs, or the surroundings of the vehicle. The sensor data may be in the form of the real time traffic, hazard warning, road signs, and the like. The sensor data indicates at least one of a driving condition of the vehicle in the region or a surrounding environmental condition of the vehicle.

At step 503, the method 500 comprises instructions to determine a function class of each of the plurality of roads based on the sensor data. Once the sensor data in the form of the real time traffic, hazard warning, road signs, etc. is received by the sensor module 201a, the sensor data is processed to extract information related to a function class of each of the plurality of roads. For example, as discussed previously in FIG. 3 and FIG. 4, the functional class is a road type indicator, reflecting traffic speed and volume, as well as the importance and connectivity of the road. The function class indicator may be received as a data parameter in the sensor data. For example, the sensor data may be in the form of a message that indicates a function class parameter, like FC1, FC2, FC3, and the like.

At step 505, the method 500 comprises instructions to determine a type of a vehicle associated with the user equipment 105. In some embodiments, the vehicle data obtained from the sensor module 201a, includes an identifier of the vehicle. The processor 201 may be configured to determine the type of the vehicle based on the identifier of the vehicle. The type of the vehicle may include also include information about such as level of autonomy of the vehicle, brand of the vehicle or the OEM of the vehicle, and the like. For example, the level of autonomy may be any of level 0, level 1, level 2, level 3, level 4, and level 5.

At step 507, the method 500 comprises instructions to determine coverage data of the vehicle for each of the plurality of roads based on the function class of a respective road of the plurality of roads and the type of the vehicle. For example, as discussed in FIG. 4, the sensor data and the vehicle data may be aggregated and then different types of analysis are performed on the aggregated data, like coverage (data) analysis and statistical data analysis. The coverage analysis may be based on the accumulating of data/time span period per region or polygon, per road function class, per provider, or other filters like rush hour vs non-rush hour, holiday vs non holiday, weekdays vs weekends. In some embodiments, the coverage of the vehicle for each of the plurality of roads indicates mileage on the respective road. In some embodiments, the system 101 may calculate total mileage of the vehicle in a region based on analysis of the mileage on each of the plurality of roads in the region. The system 101 may generate statistical data metrics and visualization for both the coverage data and the statistical data metrics for the vehicle on each of the plurality of roads based on the function class of the respective road and the type of the vehicle.

At step 509, the method 500 comprises instructions to output a first notification associated with the coverage data of the vehicle. To that end, the system 101 is configured to compare the coverage data of the vehicle for each of the plurality of roads with a respective threshold value of a plurality of threshold values. For example, the plurality of threshold values may include percentage values indicating percentage of sensor data coverage, for different function classes. In the same example, a road of type FC1 in a region, travelled by a vehicle may have a threshold value of 49%, which indicates that the sensor data coverage on the FC1 type road in the region should be at least 49% for correct indications and accurate navigation. The vehicle travelling on such FC1 road may be a level 2 autonomous vehicle and its sensors may be able to provide only 21% coverage while travelling on the FC1 road. Thus, this coverage data indicating 21% coverage may be compared with the threshold value of the FC1 road, which is 49%, and then next step would be to output the first notification, based on the comparison. Similarly, there may be other threshold values, for other types of roads, and coverage data of the vehicle for different roads may be different. Further, the first notification may be in the form of a display indication, an alert message, a warning notification and the like to indicate the coverage data of the vehicle to a user while travelling in the vehicle in a particular type of road. Similarly, the system 101 may be configured to generate a second notification and a third notification based on the comparison of the coverage data of the vehicle with a threshold value of the plurality of threshold values. This step is explained in detail in FIG. 6.

In this manner, the method 500 may be configured to enable navigation of vehicles in a real-time and reliable manner. The method 500 may be implemented using corresponding circuitry. For example, the method 500 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 500.

In an example embodiment, an apparatus for performing the method 500 of FIG. 5 above may comprise a processor (e.g., the processor 201) configured to perform some or each of the operations of the method 500. The processor may, for example, be configured to perform the operations (501-509) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (501-509) may comprise, for example, the processor 201 which may be implemented in the system 101 and/or a device or circuit for executing instructions or executing an algorithm for processing information as described above.

FIG. 6 illustrates another flow diagram of a method 600 for determining coverage data of a vehicle, in accordance with an example embodiment. At step 601, the method 600 comprises instructions to compare a coverage of a vehicle, as indicated by the coverage data of the vehicle, for each of a plurality of roads with a respective threshold value of a plurality of threshold values. The plurality of threshold values are associated with each of a plurality of function class corresponding to the plurality of roads. Each function class has a different threshold value for determination of coverage of a vehicle. Threshold value corresponding to a function class is affected by factors such as road type, traffic speed and volume, connectivity of the road.

At step 603, the method 600 comprises instructions to analyze the comparison results obtained in step 601. The result of comparison is analyzed by the system 101 to check if the coverage data of the vehicle for at least one road of the plurality of roads is equal to or greater than at least one threshold value for one road of the plurality of roads. Further, the system 101 analyzes the comparison results and generates a second notification and/or a third notification based on the result of analysis.

At step 605, the method comprises instructions to output a second notification, when the coverage of the vehicle for at least one road of the plurality of roads is equal to or greater than at least one threshold value. When the comparison indicates that the determined coverage is more than the predefined threshold for that road, it indicates that performance of the vehicle is good corresponding to the function class of that road of the plurality of the roads.

At step 607, the method 600 comprises instructions to output a third notification, when the coverage of the vehicle for at least one road of the plurality of roads is less than at least one threshold value. The system 101 may control a display device to display a warning based on the third notification. The warning may be an indication of poor performance of the vehicle of the road where the coverage of the vehicle is lesser than the expected threshold value.

Further, the results of the coverage data comparison described in methods 500 ad 600 may be further used for performing statistical analysis of various types of vehicles and their sensors. Such analysis may be done by types of vehicles, types of OEMs, per function class, per sensor type, per region, per polygon and the like. The results of these analysis may be useful to compare different types of vehicles, different types of OEMs, different types of sensors etc. The results of such analysis may also be useful in industries such as insurance industry, to evaluate the OEM autonomous vehicle sensor data coverage analysis by brand to evaluate the risk of determining the insurance premium. Additionally, such analysis may also be useful to evaluate different types of regions based on their coverage.

In this way, example embodiments of the disclosure results in determining coverage of a vehicle. The present disclosure also provides aid in autonomous driving. Determining coverage of vehicle using sensor data is important for autonomous driving. Accordingly, the vehicle data related to the performance of the vehicle should be up to date in real time for various navigation applications such as in autonomous driving applications. To that end, the present disclosure provides methods and systems for determining coverage analysis of a vehicle to accurately provide the map data such that the unwanted situations such as road accidents, traffic congestions, wastage of vehicle mile and increased travel time may be avoided.

In this manner, the present disclosure provides efficient and user-friendly techniques for updating navigation instructions. The present disclosure facilitates updated navigation instructions related to routing of traffic. Along with this, in some embodiments, most of the processing is done by a remote server based or cloud-based server, so the end user may be able to leverage fast processing and improved storage benefits provided by the present disclosure. Thus, the navigation instructions may be generated based on up-to-date and real time data, providing accurate and reliable navigation services to the end users.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system, comprising:
a memory configured to store computer-executable instructions; and
at least one processor configured to execute the computer-executable instructions to:
acquire sensor data and vehicle data from a user equipment, wherein the sensor data is associated with a region including a plurality of roads;
determine a function class of each of the plurality of roads based on the sensor data;
determine a type of a vehicle associated with the user equipment, based on the vehicle data;
determine coverage data of the vehicle for each of the plurality of roads based on the function class of a respective road of the plurality of roads and the type of the vehicle; and
output a first notification associated with the coverage data of the vehicle.

2. The system according to claim 1, wherein the at least one processor is further configured to:
compare the coverage data of the vehicle for each of the plurality of roads with a respective threshold value of a plurality of threshold values, the plurality of threshold values being associated with the plurality of roads such that each road of the plurality of roads has a corresponding threshold value;
output a second notification when the coverage data of the vehicle for at least one road of the plurality of roads is one of equal to or greater than at least one threshold value, wherein the plurality of threshold values includes the at least one threshold value; and
output a third notification when on the coverage data of the vehicle for the at least one road is less than the at least one threshold value.

3. The system of claim 2, wherein the at least one processor is further configured to control a display device to display a warning based on the third notification.

4. The system of claim 1, wherein the coverage data of the vehicle for each of the plurality of roads indicates mileage of the vehicle on the respective road.

5. The system of claim 4, wherein the at least one processor is further configured to calculate total mileage of the vehicle in the region based on analysis of the mileage on each of the plurality of roads.

6. The system of claim 1, wherein the at least one processor is further configured to:
generate statistical data metrics for the vehicle on each of the plurality of roads based on the function class of the respective road and the type of the vehicle; and
control a display device to display the generated statistical data metrics for the vehicle.

7. The system of claim 6, wherein the at least one processor is further configured to execute histogram analysis for the vehicle on each of the plurality of roads based on the generated statistical data metrics.

8. The system of claim 6, wherein the at least one processor is further configured to:
classify the generated statistical data metrics based on a degree of importance of a specific time period; and
execute statistical analysis on the classified statistical data metrics based on the degree of importance of the specific time period.

9. The system of claim 1, wherein the vehicle data includes an identifier of the vehicle, and the at least one processor is further configured to determine the type of the vehicle based on the identifier of the vehicle.

10. The system of claim 1, wherein
the vehicle comprises a plurality of sensors, and
the at least one processor is further configured to generate statistical data metrics for the vehicle based on a category of each sensor of the plurality of sensors.

11. The system of claim 1, wherein the sensor data indicates at least one of a driving condition of the vehicle in the region or a surrounding environmental condition of the vehicle.

12. The system of claim 1, wherein the at least one processor is further configured to:
receive dynamic data from a server based on the reception of the sensor data;
execute a map matching process for the vehicle based on the sensor data and the dynamic data; and
determine the coverage of the vehicle for each of the plurality of roads based on the execution of the map matching process.

13. A method, comprising:
acquiring sensor data and vehicle data from a user equipment, wherein the sensor data is associated with a region including a plurality of roads;
determining a function class of each of the plurality of roads based on the sensor data;
determining a type of a vehicle based on the vehicle data;
determining coverage data of the vehicle for each of the plurality of roads based on the function class of a respective road of the plurality of roads and the type of the vehicle; and
outputting a first notification associated with the coverage data of the vehicle.

14. The method of claim 13, further comprising:
comparing the coverage data of the vehicle for each of the plurality of roads with a respective threshold value of a plurality of threshold values, the plurality of threshold values being associated with the plurality of roads such that each road of the plurality of roads has a corresponding threshold value;
outputting a second notification when the coverage data of the vehicle for at least one road of the plurality of roads is one of equal to or greater than at least one threshold value for the at least one road, wherein the plurality of threshold values includes the at least one threshold value; and
outputting a third notification when the coverage data of the vehicle for the at least one road is less than the at least one threshold value.

15. The method of claim 14, further comprising controlling a display device to display a warning based on the third notification.

16. The method of claim 13, wherein the coverage data of the vehicle for each of the plurality of roads indicates mileage of the vehicle on the respective road.

17. The method of claim 16, further comprising:
calculating total mileage of the vehicle in the region based on analysis of the mileage on each of the plurality of roads.

18. The method of 13, further comprising:
generating statistical data metrics for the vehicle on each of the plurality of roads based on the function class of the respective road and the type of the vehicle; and
controlling a display device to display the generated statistical data metrics for the vehicle.

19. The method of 13, further comprising:
receiving dynamic data from a server based on the reception of the sensor data;
executing a map matching process for the vehicle based on the sensor data and the dynamic data; and
determining the coverage data of the vehicle for each of the plurality of roads based on the execution of the map matching process.

20. A non-transitory computer-readable medium having stored thereon computer-executable instructions, which when executed by a computer, cause the computer to execute operations, the operations comprising:
acquiring sensor data and vehicle data from a user equipment, wherein the sensor data is associated with a region including a plurality of roads;
determining a function class of each of the plurality of roads based on the sensor data;
determining a type of a vehicle based on the vehicle data;
determining coverage data of the vehicle for each of the plurality of roads based on the function class of a respective road of the plurality of roads and the type of the vehicle; and
outputting a first notification associated with the coverage data of the vehicle.
